(19) United States
(12) Patent Application Publication
(10) Pub. No.: US 2009/0313653 A1
(43) Pub. Date: Dec. 17, 2009

(54) SYSTEM CAPABLE OF BROADCASTING INFORMATION BY DESIGNATED DISPLAYING FRAMES IN DESIGNATED LOCATIONS AND TIME PERIODS, AND ITS METHODS

(75) Inventors: Allen CHIEN, Taipei City (TW); Chun-Chih Wu, Taipei City (TW)

Correspondence Address: Muncy, Geissler, Olds & Lowe, PLLC, P.O. BOX 1364, FAIRFAX, VA, 22038-1364, US

(73) Assignee: KiSmart Corp.

(21) Appl. No.: 12/139,893

(22) Filed: Jun. 16, 2008

(51) Int. Cl. H04N 7/10

(52) U.S. Cl. 725/32

(57) ABSTRACT

A system capable of broadcasting information by designated displaying frames in designated locations and time periods, comprises a server and some displays. The server, the displays and at least one terminal are connected with each other via communication networks. After one terminal selects one display, one time period and one displaying frame for broadcasting, and providing broadcasting contents for the selected displaying frame, the server transmits the information of the broadcasting time period, the displaying frame and the broadcasting contents to the selected display. The selected display outputs the broadcasting contents on the selected displaying frame thereof according to the information of the time period.

### BACKGROUND

1. Field of Invention

This invention is related to a system capable of broadcasting information, and more particularly to a system capable of broadcasting information by designated displaying frames in designated locations and time periods, and its method.

2. Description of Related Art

The conventional advertisement seller obtains a franchise from broadcasting mass media like printed media or electronic media broadcasting information widely in locations, and sells the remaining advertising slots of the broadcasting mass media to the potential advertisement buyers in a manner of “pulling type”. After an advertisement buyer bought one in the remaining advertising slots, the broadcasting mass media does not publish the sold advertisement on a desired position by the advertisement buyer's decision.

However, some advertisement buyers who only want to focus to theirs desired consuming groups choose for some proper styles of broadcasting mass media but unable to deliver advertisements to a specific location in a specific period. For example, white-collar employees who work in a commercial location mostly stay in the commercial location during the working hours. While the white-collar employees all leave the commercial location, advertisements in the commercial location brings little advertising effect. Advertiser of that is hard to evaluate the campaign of the advertising whether is successful or not. Therefore, the troubles and confusions must to be improved to concentrate the advertising effect and save the budget of propaganda.

### SUMMARY

It is therefore an aspect of the present invention to present a system capable of broadcasting information by designated displaying frames in designated locations and time periods and its method thereof to provide advertisement buyers to publish information (advertisement or non-advertisement) only focusing on specific consuming groups in a specific location in connection with a specific period.

Another aspect of the present invention is to provide partitioned frames on a displaying screen for both broadcasting much more information at a same time period and concentrating the effect of the advertisement, and to allow choosing the properly priced partitioned frame according to the buyer's budget.

For the foregoing, the present invention provides a system capable of broadcasting information by designated displaying frames in designated locations and time periods, the system comprises displaying means, computing means and communication networking means. The computing means is used for providing interfaces for terminals to input information of broadcasting display, broadcasting time period, displaying frame, to proceed a payment procedure for that, and to upload broadcasting contents for the displaying frame after finishing the payment procedure, processing displaying size and time of the broadcasting contents to conform the information of the displaying frame and the broadcasting time period, and the computing means is also used for transmitting the information of the broadcasting time period, the displaying frame and the broadcasting contents to the displaying means according to the information of the broadcasting display.

The displaying means is used for receiving information of the broadcasting time period and the displaying frame, for receiving the broadcasting contents corresponding to the displaying frame from the computing means, and for rendering an output of the broadcasting contents on one frame accommodating to the information of the displaying frame within one time period according to the information of the broadcasting time period.

The communication networking means is used for transmitting the forgoing information of the broadcasting display, the broadcasting time period, the displaying frame, information of the payment procedure, and the broadcasting contents from one of the terminal to the computing means, and for transmitting information of the broadcasting time period, the displaying frame and the broadcasting contents from the computing means to the displaying mean.

Another description of the system in the present invention comprises a server and some displays. The server electrically connects to one or more terminals and the displays via communication networks in order to provide interfaces for the terminals to input information of selected broadcasting display, broadcasting time period, and displaying frame, to proceed a payment procedure for that, and to upload broadcasting contents for the selected displaying frame.

The server receives the information of selected broadcasting display, the selected broadcasting time period, the selected displaying frame, and the uploaded broadcasting contents from the terminal that has finished the payment procedure only, and then transmits the information of the selected broadcasting time period, the selected displaying frame and the uploaded broadcasting contents to the broadcasting display selected by the terminal that has finished the payment procedure.

Each of the displays is respectively placed at different locations, and each selected display renders an output of the uploaded broadcasting contents on a frame accommodating to the information of the selected displaying frame within a time period according to the information of the selected broadcasting time period.

The invention further provides a method of broadcasting information by designated displaying frames in designated locations and time periods, the method comprises a first step of enabling the server to respectively provide interfaces to the terminals for inputting information of selected broadcasting display, selected broadcasting time period, selected displaying frame, and for proceeding a payment procedure for that, a second step of only enabling the terminal that has finished the payment procedure to upload broadcasting contents corresponding to the selected displaying frame, a third step of processing displaying size and time of the broadcasting contents to conform the information of the displaying frame and the broadcasting time period, a fourth step of enabling the server to transmit information of the selected broadcasting time period and the selected displaying frame, and the uploaded broadcasting contents to each display selected by the terminal that has finished the payment procedure, and a fifth step of enabling each selected display to render an output of the uploaded broadcasting contents on at least one frame accommodating to the information of the selected displaying frame within one time period according to the information of the selected broadcasting time period.

### BRIEF DESCRIPTION OF THE DRAWINGS

These and other features, aspects and advantages of the present invention will become better understood with regard to the following description, appended claims and accompanying drawings where:

FIG. 1 is a simplified system block diagram of the present invention;

FIG. 2 is a function block diagram of a display in one preferred embodiment of the present invention;

FIG. 3 is a function block diagram of a server in the preferred embodiment of the present invention;

FIG. 4 is a schematic diagram of an identified code list of the server in the preferred embodiment of the present invention;

FIG. 5 is an exemplary screen of a first web page interface of the server in the preferred embodiment of the present invention;

FIG. 6a is one of the diversified displaying frame layouts in the preferred embodiment of the present invention;

FIG. 6b is one of the diversified displaying frame layouts in the preferred embodiment of the present invention;

FIG. 6c is one of the diversified displaying frame layouts in the preferred embodiment of the present invention;

FIG. 6d is one of the diversified displaying frame layouts in the preferred embodiment of the present invention;

FIG. 7 is an exemplary screen of a second web page interface of the server in the preferred embodiment of the present invention;

FIG. 8 is a flow chart of a method in the server to broadcast information by designated displaying frames in designated locations and time periods in the preferred embodiment of the present invention;

FIG. 9 is a schematic diagram of a broadcasting schedule of the server in the preferred embodiment of the present invention;

FIG. 10 is a flow chart of a method in the display to broadcast information by designated displaying frames in designated locations and time periods in the preferred embodiment of the present invention.

### DESCRIPTION OF THE PREFERRED EMBODIMENTS

It is to be understood that the following disclosure provides one or more preferred embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This invention discloses system capable of broadcasting information by designated displaying frames in designated locations and time periods. The system provides a platform for buyers who would like to broadcast information such as advertisements or, non-advertisements (e.g. public information, exhibition works and the like) by a designated displaying frame in designated locations and time periods only. The buyers can preliminarily choose one or more outdoor electronic billboards, one or more time periods for broadcasting, and one or more partitioned frames on each outdoor electronic billboard to present the contents, and provide one or more digital files for desired contents corresponding to each frame via communication networks. Therefore, the system disseminates the desired contents focusing on specific consuming groups only by the specific locations in connecting with the specific time periods to concentrate the disseminating effect. Also, the system provides more than one frame for broadcasting the desired contents at a same time to allow the buyers choosing the fair price of partitioned frame according to their budget.

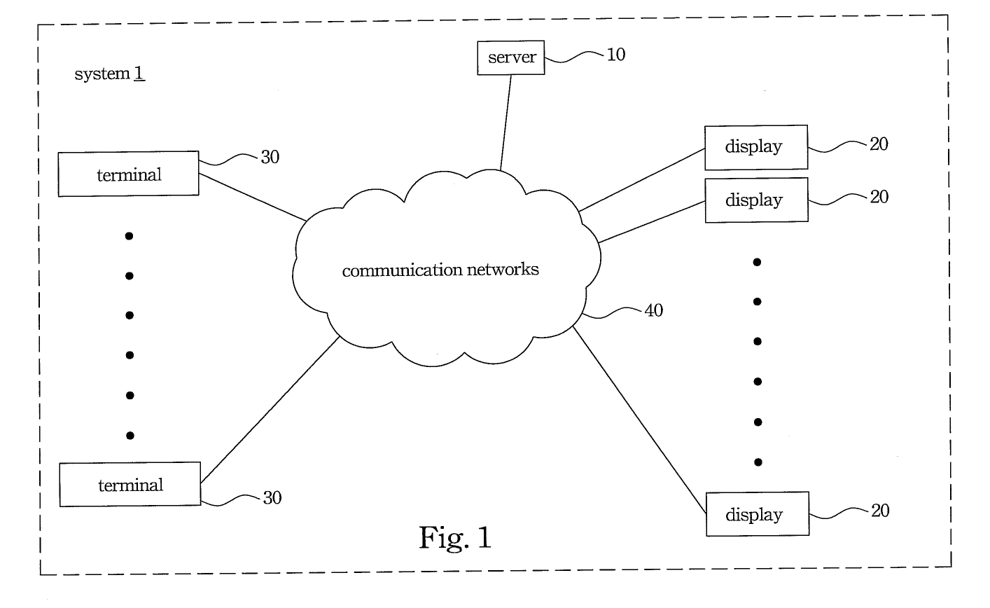

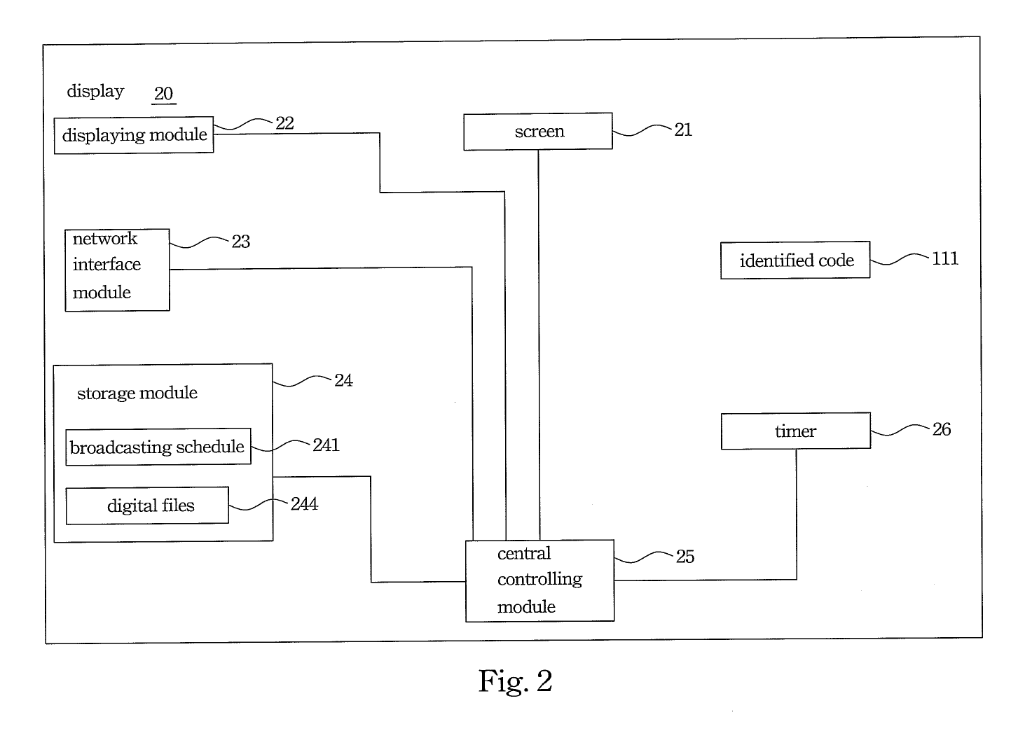

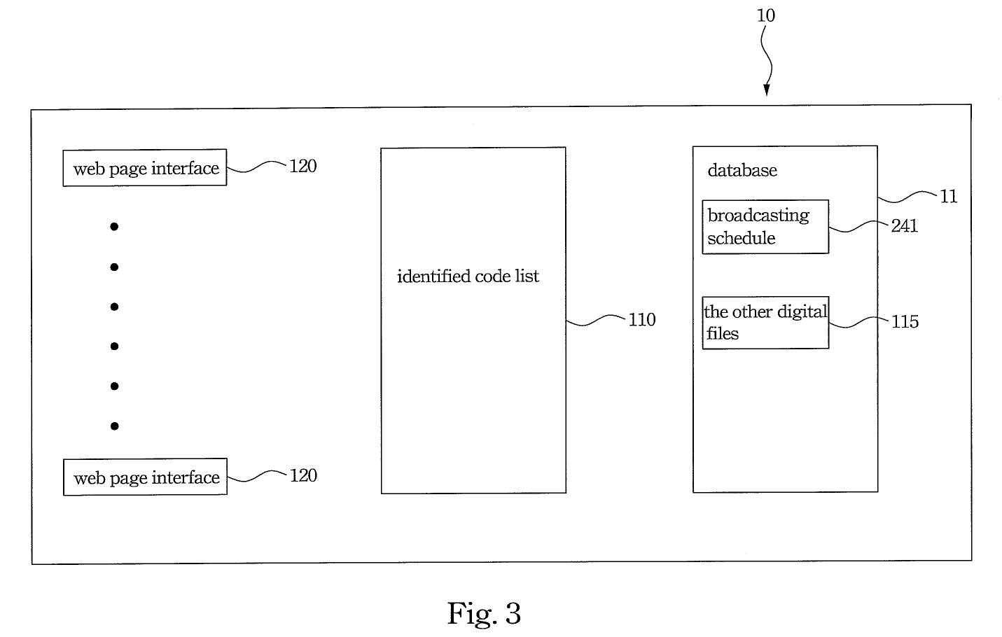

Refer to FIG. 1, FIG. 2 and FIG. 3. In a preferred embodiment, the system 1 includes a server 10, a number of displays 20 and a number of terminals 30. Each of these displays 20, especially a flat panel display, a large scale LED billboard or alike, is widely set at one of many locations, such as shopping malls, supermarkets, stores, gas stations, public transportation stations or sport courts etc., and is oriented properly for people to view. Thus, each of these displays 20 is given an exclusively identified code 111 for distinguishability.

On the other hand, the server 10, especially a network server, a web server or a workstation, respectively electrically connects to each display 20 and each terminal 30 (e.g. the mentioned buyers or a terminal node) directly or indirectly via communication networks 40. The server 10 has a database 11, an identified code list 110 and a number of web page interfaces 120.

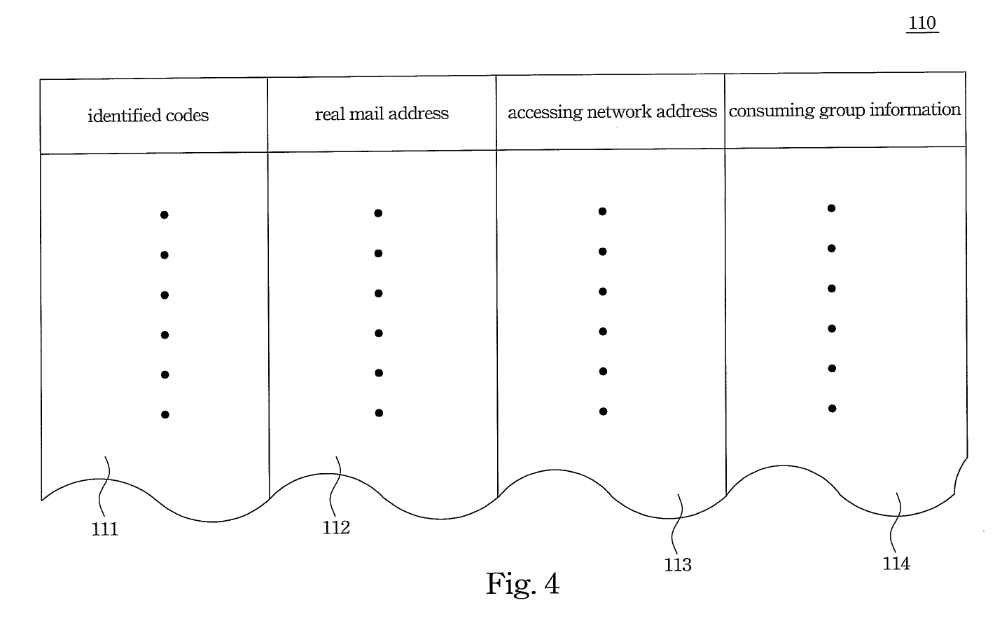

Refer to FIG. 3 and FIG. 4. The identified code list 110 is filled with identified code 111, real mail addresses 112 and network accessing address 113 of each display 20. Each of the network accessing addresses 113 respectively corresponds to one of the identified codes 111. More particularly, the identified code list 110 further has a plurality of consuming group information 114 (e.g. consumer's gender, age or purchasing amounts). The consuming group information 114 can be preliminarily collected by a marketing survey provider from those locations mentioned above. Each of the consuming group information 114 respectively corresponds to one of the identified codes 111.

Once those terminals 30 are connecting to the server 10 over the communication networks 40, the web page interfaces 120 of the server 10 are provided for selecting at least one display 20 for broadcasting, at least one time period for broadcasting, and at least one displaying frame for broadcasting on the display 20, for proceeding a related payment procedures for obtaining the exclusive right to broadcast information by the above selected environments after one of the terminals finished inputting the information of the selected broadcasting display(s), the selected broadcasting time period(s), and the selected displaying frame(s), and for uploading the desired contents for broadcasting on the corresponding displaying frame.

Thus, after one of the terminals finishing the payment procedures therefor, the server 10 will collect the information of the selected broadcasting display(s), the selected broadcasting time period(s), the selected displaying frame and the corresponding broadcasting contents. After collecting all the information above, the server 10 will process displaying size and time of the broadcasting contents to conform the information of the displaying frame and the broadcasting time period.

The server 10 then identifies any of the displays 20 if it matches the received information of selected broadcasting display and sends the information of the selected broadcasting time period, the selected displaying frame and the broadcasting contents to the selected display 20.

To grant the exclusive right of broadcasting information after the specific broadcasting display(s), broadcasting time period(s), and displaying frame being selected, the system 1 provides those terminals 30 either a fixed price to purchase directly or blank field to offer a bid amount in a predetermined auction time. Thus, those terminals 30 can directly purchase it or offer a bid amount for the popular locations of the displays 20, the desired time periods, and/or the desired displaying frames for broadcasting.

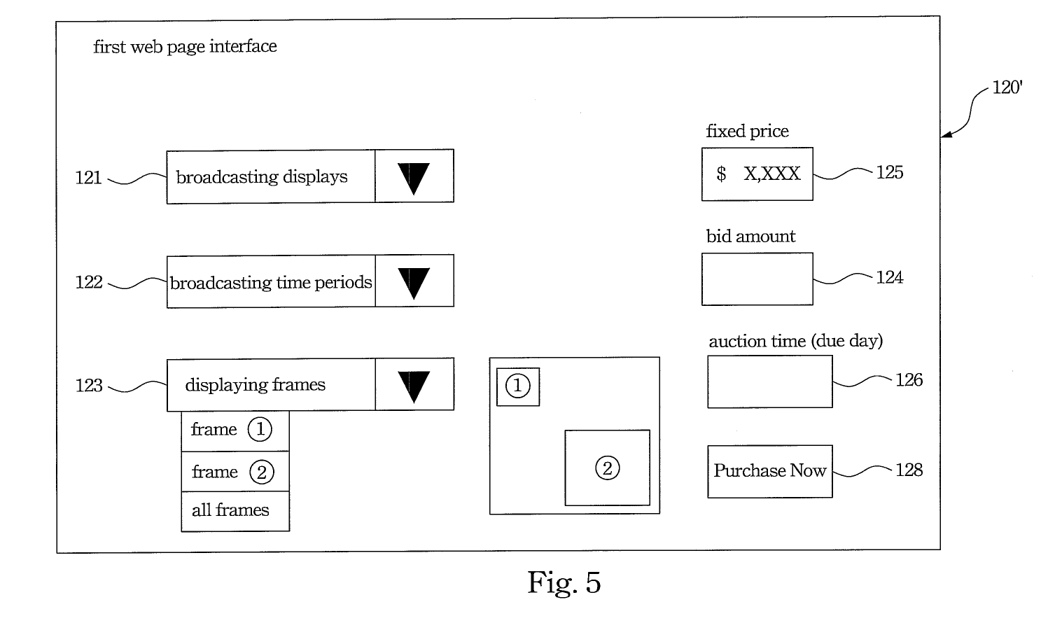

Refer to FIG. 5. In this embodiment, a first web page interface 120′ provides some selecting lists of broadcasting displays 121, broadcasting time periods 122 and displaying frame 123, a fixed price 125 for directly purchase and a clickable image 128 for finishing the payment procedure.

Refer back to FIG. 5 again. The first web page interface 120′ further provides an input cell 124 for a bid amount for those terminals 30 to offer and an auction time 126 thereon for bid.

The selecting list of broadcasting displays 121 provides the available displays 20, their real mail addresses 112 and their corresponding consuming group information 114 which are all loaded from the identified code list 110, for the terminals 30 to simply choose or multiple choose.

The selecting list of broadcasting time periods 122 provides some available time periods for broadcasting information. These time periods appear with dates and times for those terminals 30 to simply choose or multiple choose.

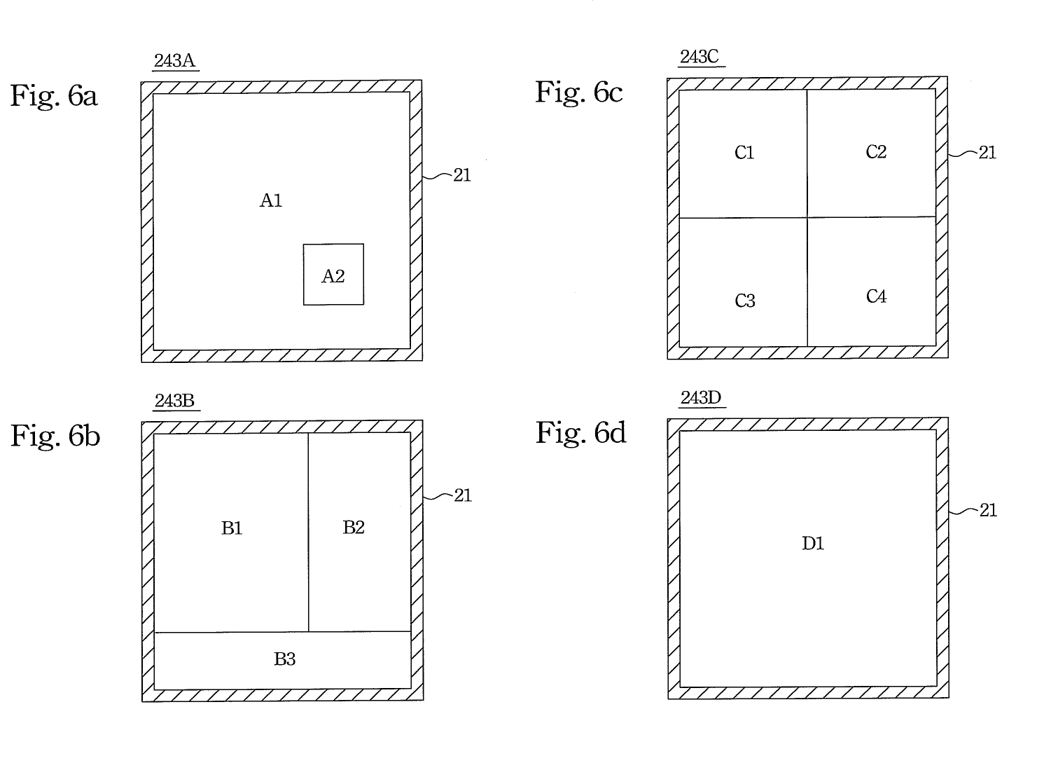

Refer to FIG. 6a, FIG. 6b, FIG. 6c and FIG. 6d. The selecting list of displaying frames 123 provides those terminals 30 to choose at least one displaying frame A1˜A2, B1˜B3, C1˜C4, or D1 of a predetermined displaying frame layout 243A, 243B, 243C or 243D. For instance, the chosen displaying frame can be a frame A1 out of the displaying frame layout 243A (see FIG. 6a), one of multi-divided frames B1-B3, C1-C4 out of the displaying frame layout 243B, 243C (see FIG. 6b, FIG. 6c), wherein the frame B3 can be a banner for scrolling text marquee, or a whole frame D1 out of the displaying frame layout 243D (see FIG. 6d). Note that the predetermined displaying frame layouts are not limited in those from FIG. 6a˜FIG. 6d only.

The clickable image 128 provides the terminal 30 to directly purchase the exclusive right for broadcasting information according to the fixed price 125, or the terminal 30 that offers a highest bid amount to purchase the exclusive right for broadcasting information according to the offered bid amount.

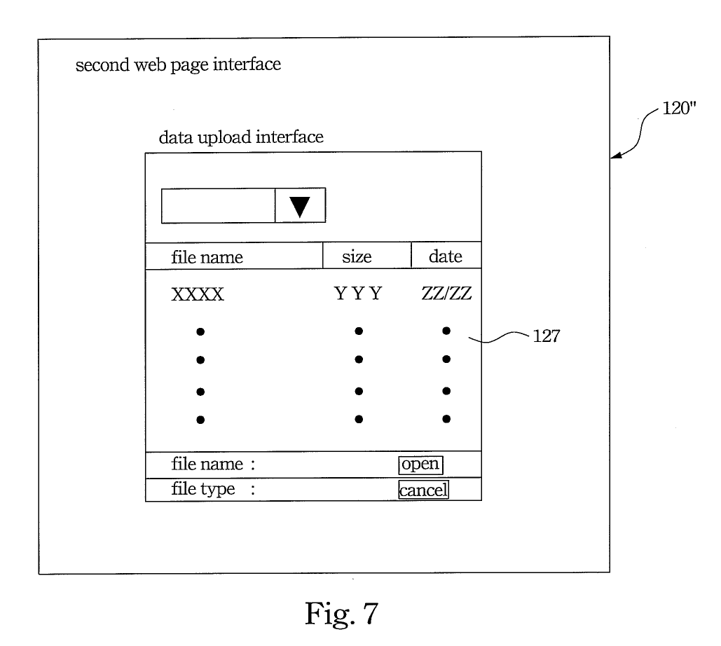

After the server 10 receiving the information of the payment procedure, the server provides a second web page interface 120″ for the terminal that finished has the payment procedure. Refer to FIG. 7. The second web page interface 120″ provides a data upload interface 127 for the terminal 30 finishing the payment procedure to upload the corresponding broadcasting contents. The broadcasting contents can be presented by a digital file 244 (see FIG. 2) or another digital file 115 (see FIG. 3) directed from a hyper-linking address in a predetermined site (e.g. the server 10) via the communication networks 40.

The contents of the digital file 115 or 224 can be an advertisement (i.e. static image or animated video), public information (e.g. news, weather forecast, map providing, traffic information and policy announcement) and works exhibition.

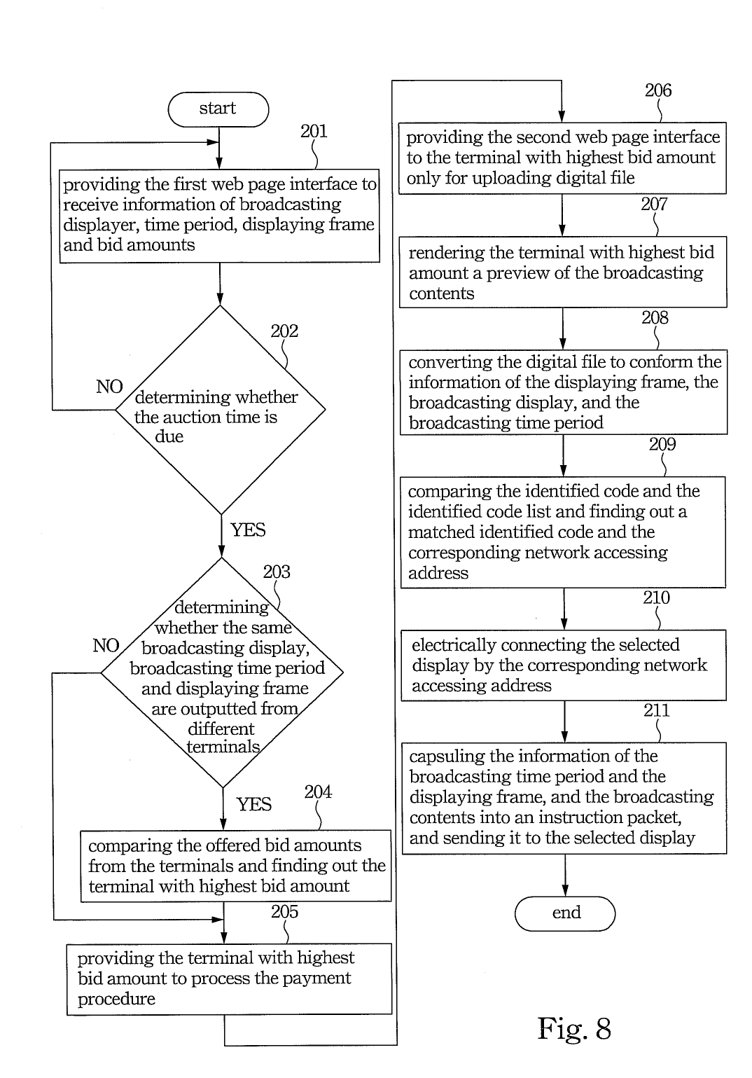

When the server 10 electrically connects at least two terminals 30 via the communication networks 40, refer to FIG. 8, the system 1 works as the following steps:

Step (201) the server 10 provides the first web page interface 120′ for the terminals 30 to do the selecting lists of broadcasting display 121, time periods 122 and displaying frames 123 and for the terminals 30 to offer bid amounts in the input cell 124. After the terminals 30 finishing the selecting lists thereof 121, 122, and 123 and the input cell 124, the server 10 therefore receives some information of the selected broadcasting display(s), the selected broadcasting time period(s), the selected displaying frame(s) and offered bid amounts and stores temporarily them in the database 11. Here, the information of the selected broadcasting display contains the identified code(s) 111 and the network accessing address 113 of the display(s) 20 from the identified code list 110.

Step (202) the server 10 determines whether the auction time 126 is due, if yes, process step (203), otherwise, back to process step (201) again;

Step (203) the server 10 determines whether the same information of the selected broadcasting display(s), the selected broadcasting time period(s) and the selected displaying frame(s) are outputted separately from the different terminals 30; if yes, process step (204), otherwise, process step (205);

Step (204) the server 10 compares the offered bid amounts from the terminals 30 to find out the terminal 30 that offers the highest bid amount.

Step (205) the server 10 provides a wining terminal 30 that offers the highest bid amount to proceed the payment procedure therefor by clicking the clickable image 128 of the first web page interface 120′;

Step (206) the server 10 provides the second web page interface 120″ to the winning terminal 30 only for uploading at least one digital file 115 or the other digital file 115 via at least one hyper-linking address for the corresponding displaying frame to the server 10. In here, each displaying frame independently corresponds to a broadcasting time period and broadcasting contents;

Step (207) the server 10 renders the wining terminal 30 at least one preview of the uploaded broadcasting contents on the designated displaying frame;

Step (208) the server 10 processes the digital file 115 or 244 to convert the displaying size, file format, and/or displaying time thereof in order to conform the selected displaying frame(s), the selected broadcasting display, and the selected broadcasting time period(s);

Step (209) the server 10 compares the identified code 111 from the information of the selected broadcasting display and the identified code list 110, and finds out a matched identified code 111 and a network accessing address 113 corresponding to the matched identified code 113 from the identified code list 110;

Step (210) the server 10 electrically connects the display(s) 20 via the communication networks 40 according to the network accessing address 113 corresponding to the matched identified code 111 in the identified code list 110;

Step (211) the server 10 capsules the corresponding information of the selected broadcasting time period(s) and the selected displaying frame(s), and the corresponding broadcasting contents into at least an instruction packet, and sending the instruction packet to the display 20 according to the network accessing address 113 corresponding to the matched identified code 111.

Another possible in step (206), the server 10 may provide the network accessing address 113 corresponding to the matched identified code 111 to the winning terminal 30 to upload the digital file 115 or the hyper-linking address directly to the selected display 20 without passing through the server 10. Therefore, the selected display 20 must in charge of the step (208) to convert the displaying size, the file format, or the displaying time of the digital file 115 or 244.

Thus, each of the selected displays 20 then displays the corresponding broadcasting contents only through a frame accommodating to the information of the selected displaying frame within at least one time period according to the information of the selected broadcasting time period. The details of display 20 will be further introduced in follows.

Refer to FIG. 2 and FIG. 6a˜FIG. 6d again. Each of the displays 20 at least comprises a screen 21, a displaying module 22 (e.g. a screen partitioner), a network interface module 23 (e.g. NIC), a storage module 24 (e.g. disk, RAM or EEPROM), a central controlling module 25 (e.g. CPU) and a timer 26. According to a predetermined displaying frame layout, the displaying module 22 divides the screen 21 into more than one displaying frames or integrating the displaying frames into one displaying frame. Namely, the displaying module 22 provides at least one displaying frame on the screen 21, such as a frame A1 or B1 in another frame A2 or B2, a banner B3 for scrolling text marquee, one of multi-divided frames C1˜C4, and a whole frame D1.

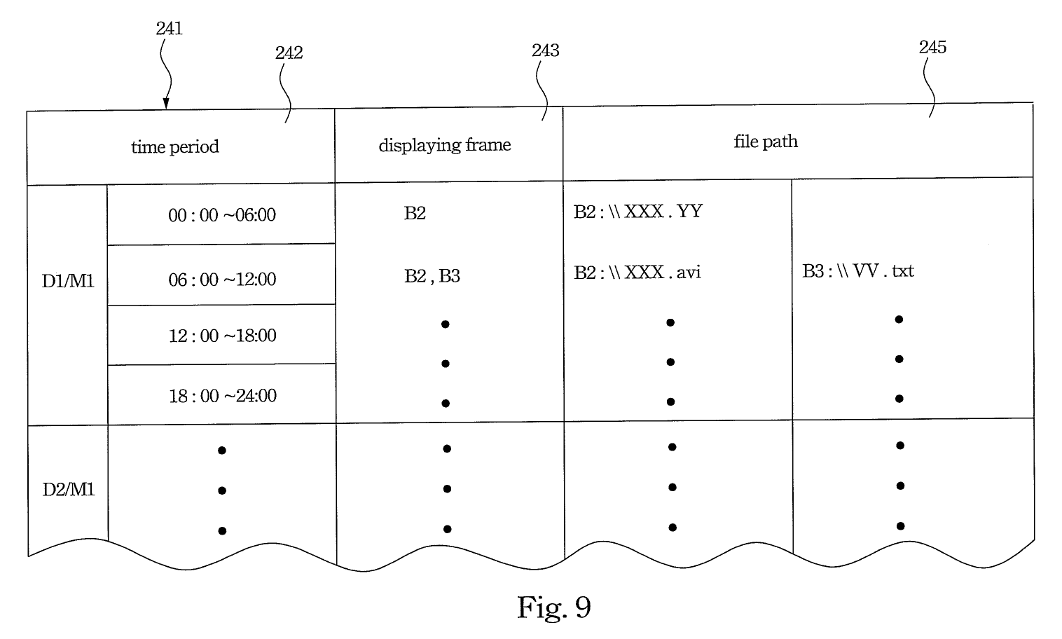

Refer to FIG. 2 and FIG. 9. The network interface module 23 electrically connects the server 10 to receive the instruction packets via the communication networks 40. The timer 26 deals with a running system time same as the real time of a local clock. The storage module 24 has a broadcasting schedule 241 filling with different information of the time period 242, the displaying frame 243 and file path 245 for displaying the right contents on the right frame within the right time. The file path 245 can be a path to the corresponding digital files 244 in the storage module 24.

The central controlling module 25 separately electrically connects the screen 21, the displaying module 22, the network interface module 23, the storage module 24 and the timer 26. When the network interface module 23 receives the instruction packets, the central controlling module 25 updates the corresponding information of the selected broadcasting time period(s) and the selected displaying frame(s), and the corresponding hyper-linking address into the broadcasting schedule 241. If the corresponding broadcasting contents is a digital file 114, the central controlling module 25 saves the digital file 114 into the storage module 24 and update its file path to the broadcasting schedule 241.

When a system time of the timer 26 matches one of the time periods 242 in the broadcasting schedule 241, the central controlling module 25 demands the displaying module 22 to prepare one or more displaying frames on the screen 21 according to the corresponding displaying frame 243 in the broadcasting schedule 241, and demands to display the corresponding broadcasting contents in broadcasting schedule 241 on prepared displaying frames.

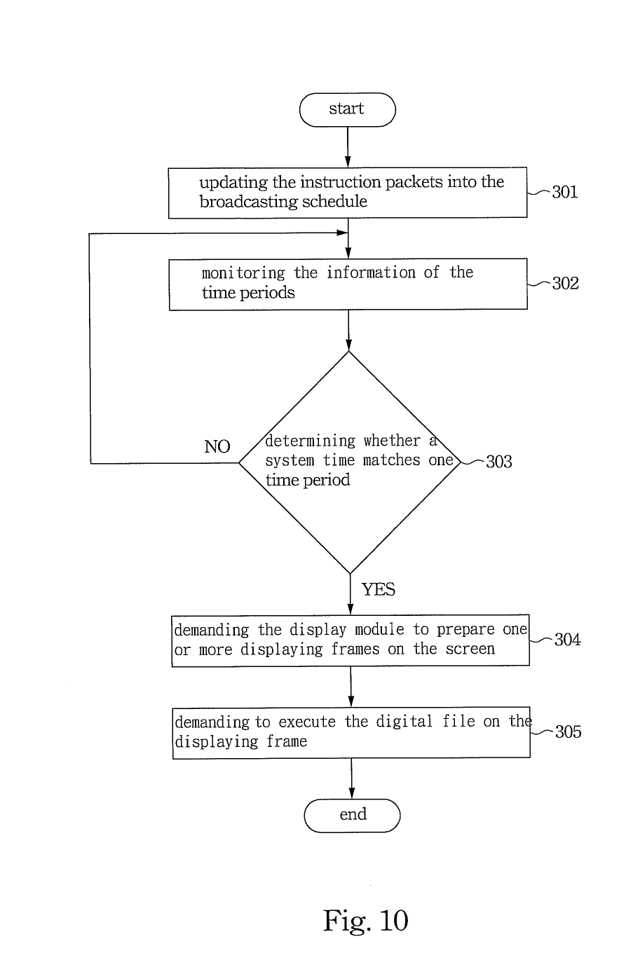

When the network interface module 23 electrically connects to the server 10 and receives an instruction packet from the server 10 via the communication networks 40, refer to FIG. 10, the central controlling module 25 works as the following steps:

Step (301) updating the instruction packets into the broadcasting schedule 241;

Step (302) monitoring the information of the time periods in the broadcasting schedule 241;

Step (303) determining whether a system time of the timer 26 matches one of the time periods from the broadcasting schedule 241, if yes, process step (304), otherwise, back to process step (302);

Step (304) demanding the displaying module 22 to prepare one or more displaying frames on the screen 21 according to the predetermined displaying frame layout;

Step (305) executing the corresponding the digital file 244, 115 according to the file path 245.

Hereby, refer to FIG. 1 again, the communication networks 40 discussed above can be, for example, private virtual networks (PVN), local area networks (LAN), wireless local area networks (WLAN), wide area networks (WAN), or intranets, or be integrated in the Internet and the combination.

Also, the server 10 can directly control the displays 20 by directly ordering the selected display 20 to arrange the displaying frame and broadcast the digital file 244 or 115 by data streaming from the server 10.

Although the present invention has been described in considerable detail with reference in the certain preferred embodiments thereof, other embodiments may be possible. Therefore, the spirit and scope of the appended claims should not be limited to the description of the preferred embodiments contained herein.

It will be apparent to those skilled in the art that various modifications and variations can be made to the structure of the present invention without parting from the scope or spirit of the invention. In view of the foregoing, it is intended that the present invention cover modifications and variations of this invention provided they fall within the scope of the following claims and their equivalents.

What is claimed is:

1. A system capable of broadcasting information by designated displaying frames in designated locations and time periods, comprising:
a server electrically connecting a plurality of terminals via communication networks, respectively providing interfaces for each terminal to input information of at least one selected broadcasting display, at least one selected broadcasting time period, at least one selected displaying frame, to proceed a payment procedure therefor, and to upload broadcasting contents for the at least one selected displaying frame after finishing the payment procedure;
a plurality of broadcasting displays electrically connecting the server via the communication networks, and each of the broadcasting displays having a screen and respectively disposed at different locations,
wherein the server transmits the information of the at least one selected broadcasting time period, the at least one selected displaying frame and the uploaded broadcasting contents to each broadcasting display selected by the terminal that has finished the payment procedure, and each selected broadcasting display renders an output of the uploaded broadcasting contents on a frame of the screen accommodating to the information of the at least one selected displaying frame within at least one time period according to the information of the at least one selected broadcasting time period.

2. The system capable of broadcasting information by designated displaying frames in designated locations and time periods as claimed in claim 1, wherein the server is used for processing the broadcasting contents to conform the selected displaying frame of the screen and the selected broadcasting time period before transmission.

3. The system capable of broadcasting information by designated displaying frames in designated locations and time periods as claimed in claim 2, wherein the broadcasting contents comprises a digital file or an hyper-linking address directing to the other one digital file.

4. The system capable of broadcasting information by designated displaying frames in designated locations and time periods as claimed in claim 3, wherein each broadcasting display comprising:
a displaying module capable of providing the screen with a predetermined displaying frame layout having at least one frame;
a network interface module capable of receiving the information of the at least one s elected broadcasting time period and the at least one selected displaying frame, and the broadcasting contents;
a storage module capable of storing the information of the at least one selected broadcasting time period and the at least one selected displaying frame, and the broadcasting contents;
a central controlling module separately electrically connecting the displaying module, the storage module and the network interface module, and demanding the displaying module to prepare the at least one frame on the screen according to the information of the at least one selected displaying frame, and to output the digital file on the at least one frame when a system time matches the information of the at least one broadcasting time period.

5. The system capable of broadcasting information by designated displaying frames in designated locations and time periods as claimed in claim 4, wherein the displaying module provides a whole frame, a frame in another frame, one of multi-divided frames, or a banner for scrolling text marquee according to the predetermined displaying frame layout.

6. The system capable of broadcasting information by designated displaying frames in designated locations and time periods as claimed in claim 1, wherein each of the broadcasting displays respectively is given an identified code, and
the server comprises an identified code list having the broadcasting displays' identified codes and a plurality of network accessing addresses, wherein each network accessing address corresponding to one of the identified codes.

7. The system capable of broadcasting information by designated displaying frames in designated locations and time periods as claimed in claim 6, wherein the identified code list further comprises a plurality of consuming group information, and each of the consuming group information respectively corresponds to one of the identified codes.

8. The system capable of broadcasting information by designated displaying frames in designated locations and time periods as claimed in claim 1, wherein the terminal that has finished the payment procedure is a terminal that offers a highest bid amount.

9. The system capable of broadcasting information by designated displaying frames in designated locations and time periods as claimed in claim 1, wherein the server renders the terminal a preview of broadcasting contents on designated displaying frame.

10. A method of broadcasting information by designated displaying frames in designated locations and time periods, which is implemented on a server, a plurality of terminals and a plurality of broadcasting displays over communication networks, the method comprising:
(a) enabling the server to respectively provide an interface to the terminals for inputting information of at least one selected broadcasting display, at least one selected broadcasting time period, at least one selected displaying frame, and for proceeding a payment procedure therefor;
(b) only enabling the terminal that has finished the payment procedure to upload broadcasting contents corresponding to the at least one selected displaying frame;
(c) enabling the server to transmit information of the at least one selected broadcasting time period and the at least one selected displaying frame, and the uploaded broadcasting contents to each broadcasting display selected by the terminal that has finished the payment procedure; and
(d) enabling each selected broadcasting display to render an output of the uploaded broadcasting contents on at least one frame accommodating to the information of the at least one selected displaying frame within at least one time period according to the information of the at least one selected broadcasting time period.

11. The method of broadcasting information by designated displaying frames in designated locations and time periods as claimed in claim 10, wherein the method before processing the payment procedure in the step (a), further comprises:
enabling the server to provide the terminals to offer a bid amount by the interface;
enabling the server to determine whether the same information of the at least one selected broadcasting display, the at least one selected broadcasting time period and the at least one selected displaying frame are inputted from the different terminals after an auction time is due; and
when the same information of the at least one selected broadcasting display, the at least one selected broadcasting time period and the at least one selected displaying frame are inputted from different terminals after the auction time is due, enabling the server to compare the bid amounts from the terminals to find out the terminal that offers the highest bid amount.

12. The method of broadcasting information by designated displaying frames in designated locations and time periods as claimed in claim 11, wherein, the method in the step (b) further comprises:
after the terminal uploading the broadcasting contents, enabling the server to render at least one preview of the uploaded broadcasting contents on the designated displaying frame to the terminal that offers the highest bid amount.

13. The method of broadcasting information by designated displaying frames in designated locations and time periods as claimed in claim 10, wherein the method in the step (c) further comprises:
enabling the server to compare an identified code from the information of the selected broadcasting display with an identified code list in the server, and finding out a matched identified code from the identified code list;
enabling the server to finding out a network accessing address of the broadcasting display corresponding to the matched identified code from the identified code list; and
enabling the server to transmit the information of the at least one selected broadcasting time period and the at least one selected displaying frame, and the broadcasting contents to the broadcasting display by the network accessing address

14. The method of broadcasting information by designated displaying frames in designated locations and time periods as claimed in claim 13, wherein the method in the step (c) further comprises:
enabling the server to process the broadcasting contents to conform the at least one selected displaying frame and the at least one selected broadcasting time period before the transmission of the information of the at least one s elected broadcasting time period and the at least one selected displaying frame, and the broadcasting contents to the at least one broadcasting display.

15. The method of broadcasting information by designated displaying frames in designated locations and time periods as claimed in claim 10, wherein the at least one broadcasting contents in the step (d) comprises a digital file or an hyperlinking address directing to the other digital file via the communication networks.

16. The method of broadcasting information by designated displaying frames in designated locations and time periods as claimed in claim 15, wherein the method in the step (d) further comprises:
enabling the selected broadcasting display to determine whether a system time thereof matches the information of the at least one selected broadcasting time period; and
when the system time matches the information of the at least one selected broadcasting time period, enabling the selected broadcasting display to prepare at least one frame thereon accommodating to the information of the at least one selected displaying frame, and to output the digital file on the at least one frame.

17. The method of broadcasting information by designated displaying frames in designated locations and time periods as claimed in claim 10, wherein the at least one frame accommodating to the information of the at least one selected displaying frame is a whole frame, a frame in another frame, one of multi-divided frames or a banner for scrolling text marquee.

18. A system capable of broadcasting information by designated displaying frames in designated locations and time periods, the system comprising:
displaying means for (1) receiving information of at least one broadcasting time period and at least one displaying frame, and broadcasting contents corresponding to the at least one displaying frame, and (2) rendering an output of the at least one broadcasting contents on at least one frame thereof accommodating to the information of the at least one displaying frame within at least one time period according to the information of the at least one broadcasting time period; and
computing means for (1) providing interfaces for a plurality of terminals for inputting information of broadcasting display, the at least one broadcasting time period, the at least one displaying frame, for proceeding a payment procedure therefor, and for uploading broadcasting contents for the at least one displaying frame after finishing the payment procedure, (2) processing the at least one broadcasting contents to conform the information of the at least one displaying frame and the at least one broadcasting time period, and (3) transmitting the information of the at least one broadcasting time period, the at least one displaying frame and the broadcasting contents to the displaying means according to the information of at least one broadcasting display;
communication networking means for (1) transmitting the information of the at least one broadcasting display, the at least one broadcasting time period, the at least one displaying frame, information of the payment procedure, and the broadcasting contents from the terminal to computing means, (2) transmitting information of the at least one broadcasting time period, the at least one displaying frame and the broadcasting contents for the at least one displaying frame from the computing means to the displaying means.
